(19) United States
(12) Patent Application Publication
(10) Pub. No.: US 2002/0173972 A1
(43) Pub. Date: Nov. 21, 2002

(54) Systems and methods of product promotion

(76) Inventors: John W. Daniel, Athens, GA (US); Ken R. Powell, Athens, GA (US)

Correspondence Address: Law Office of Jerome D. Jackson, 211 N. Union Street, Suite 100, Alexandria, VA, 22314, US

(21) Appl. No.: 09/825,938

(22) Filed: Apr. 5, 2001

(51) Int. Cl. G06F 17/60

(52) U.S. Cl. 705/1

(57) ABSTRACT

Disclosed are systems and methods of promotion within a commercial system. An exemplary embodiment of the invention generates respective invoices for various manufacturers that fund retailer-specific product discounts.

### BACKGROUND OF THE INVENTION

1. Field of the Invention

This invention relates generally to a commercial system, more particularly to a commercial system providing purchase incentives to customers.

2. Description of Related Art

Product promotions employing price discounts are a popular means to stimulate sales of products such as grocery store items. For example, discount coupons issued by a manufacturer are one type of product promotion. Product price discounts specific to a retailer are another type of product promotion. Product price discounts specific to a retailer act to promote both the product and the retailer.

### SUMMARY OF THE INVENTION

It is an object of the present invention to provide systems and methods of effecting price discounting to effect product promotions.

To achieve this and other objects of the present invention, there is a method in a system including a manufacturer and a retailer. The method comprises enabling a discounted purchase responsive to previous purchases with the retailer; and generating a signal corresponding to a transfer of funds from the manufacturer to the retailer, responsive to the discounted purchase.

According to another aspect of the present invention, there is a method in a system including a retailer, and a plurality of manufacturers each associated with a respective product. The method comprises effecting a first purchase with the retailer; selectively enabling a price adjustment for a second purchase with the retailer, the enabling being responsive to the first purchase; effecting the second purchase; and generating a signal corresponding to a transfer of funds from a selected manufacturer to the retailer, responsive to a second purchase, wherein the manufacturer is selected depending on a product subjected to the second purchase.

According to yet another aspect of the present invention, there is a processing system for a first system including a manufacturer and a retailer. The processing system comprises a plurality of first processors, in store checkout systems, that enable a discounted purchase responsive to previous purchases with the retailer; and a second processor that generates a signal corresponding to a transfer of funds from the manufacturer to the retailer, responsive to the discounted purchase.

According to yet another aspect of the present invention, there is a processing system for a first system including a retailer, and a plurality of manufacturers each associated with a respective product. The processing system comprises a first checkout station for effecting a first purchase with the retailer; a first processor that selectively enables a price adjustment for a second purchase with the retailer, the enabling being responsive to the first purchase; a second checkout station for effecting the second purchase; and a second processor that generates a signal corresponding to a transfer of funds from a selected manufacturer to the retailer, responsive to a second purchase, wherein the manufacturer is selected depending on a product subjected to the second purchase.

According to yet another aspect of the present invention, there is a processing system for a first system including a manufacturer and a retailer. The processing system comprises means for enabling a discounted purchase responsive to previous purchases with the retailer; and means for generating a signal corresponding to a transfer of funds from the manufacturer to the retailer, responsive to the discounted purchase.

According to yet another aspect of the present invention, there is a processing system for a first system including a retailer, and a plurality of manufacturers each associated with a respective product. The processing system comprises means for effecting a first purchase with the retailer; means for selectively enabling a price adjustment for a second purchase with the retailer, the enabling being responsive to the first purchase; means for effecting the second purchase; and means for generating a signal corresponding to a transfer of funds from a selected manufacturer to the retailer, responsive to a second purchase, wherein the manufacturer is selected depending on a product subjected to the second purchase.

### BRIEF DESCRIPTION OF THE DRAWINGS

FIG. 1 is a diagram of a commercial system in accordance with first preferred embodiment of the present invention.

FIG. 2 is a flowchart of a process preformed by preferred embodiments of the present invention.

FIG. 3 is a view of a part of a store in the first preferred system.

FIGS. 4A and 4B are another view of another part of the store in the first preferred system.

FIG. 5 is a sign in the store shown in FIGS. 3, 4A, 4B.

FIGS. 6A and 6B are a flowchart of a subprocess performed in the first preferred system.

FIG. 7 is a block diagram of a customer card in the first preferred system.

FIG. 8 is a diagram of a data structure shown in the card of FIG. 7.

FIG. 9 is a diagram of circuitry in a checkout station in the first preferred system.

FIG. 10 is a diagram of a table in the checkout station of FIG. 9, or in the computer of FIG. 17B.

FIG. 11 is a diagram of another process in the first preferred system.

FIG. 12 is a diagram of a commerical system in accordance with a second preferred embodiment of the present invention.

FIG. 13 is a view of part of a store in the second preferred system.

FIGS. 14A and 14B are another view of another part of the store in the second preferred system.

FIG. 15 is a sign in the store of FIG. 13,14A, and 14B.

FIG. 16 is another sign in the store of FIGS. 13, 14A and 14B

FIG. 17A is a diagram of circuitry in a checkout station of the store shown in FIGS. 13, 14A, and 14B.

FIG. 17B is a diagram of a computer in the store shown in FIGS. 13, 14A, 14B.

FIG. 18 is a diagram showing a structure of a command between two parts of the first preferred system.

FIG. 19 is a diagram showing a structure of a response between the two parts of the preferred system.

FIG. 20 is a diagram summarizing commands between two parts of the first preferred system.

FIG. 21 is a diagram showing a part of the response structure between the two parts of the preferred system.

FIG. 22 is a invoice generated by a subsystem of the second preferred system.

The accompanying drawings, which are incorporated in and which constitute a part of this specification, illustrate embodiments of the invention. Throughout the drawings, corresponding parts are labeled with corresponding reference numbers.

### DESCRIPTION OF THE PREFERRED EMBODIMENTS

First Preferred Embodiment

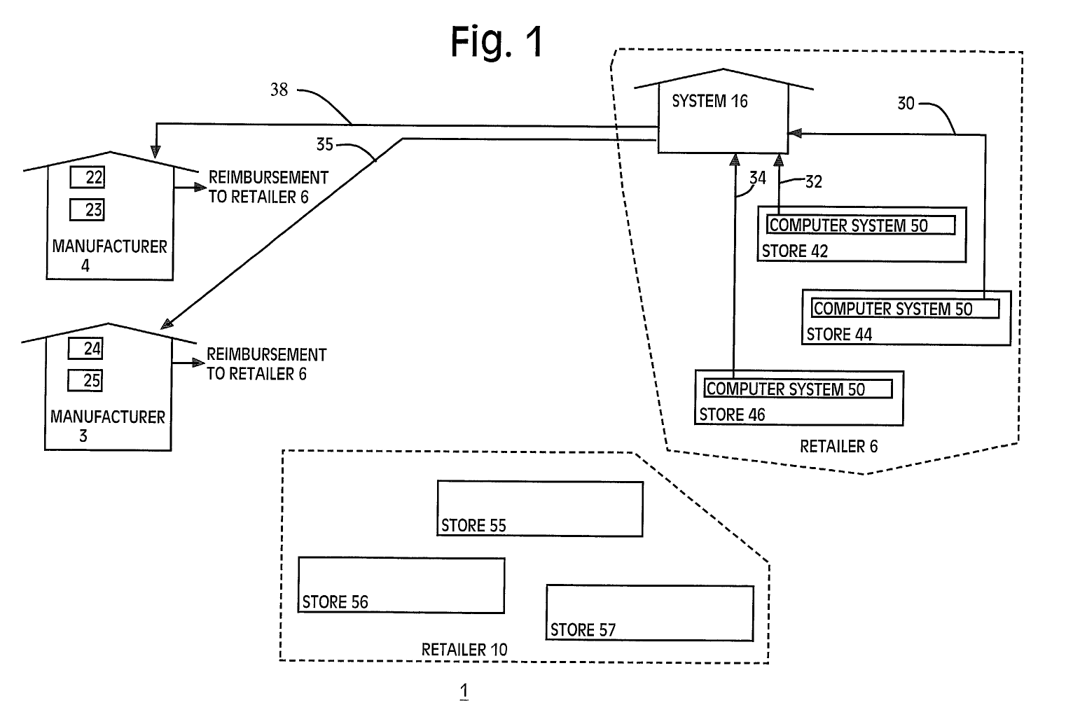

FIG. 1 shows system 1, a system of commercial promotion in accordance with a preferred embodiment of the present invention. System 1 includes manufacturer 3, manufacturer 4, retailer 10, and retailer 6. Retailer 6 includes store 42, store 44, store 46, and system 16.

Retailer 10 includes stores 55, 56, and 57.

The spatial location on the drawing sheet of FIG. 1 does not indicate geographic location. Stores within a particular retailer may be widely separated geographically, and stores of different retailers may be relatively close. For example, store 56 in retailer 10 may be in the same neighborhood as store 44 in retailer 6.

System 16 is part of retailer 6. System 16 sends data to manufacturers 3 and 4.

Manufacturers 3 and 4 may be in mutual competition. Manufacturer 4 is the Delta Company. The product line of the Delta Company includes Delta Detergent. To stimulate sales, manufacturer 4 finances product promotions consisting essentially of advertised customer discounts on sales of Delta Detergent occurring only within retailer 6. These promotions specific to retailer 6 are financed under budget 22 in manufacturer 4. Budget 22 is essentially a type of monetary amount for a product promotion and discount program for Delta Detergent.

To stimulate sales, manufacturer 4 also issues printed coupons, redeemable for a discount on Delta Detergent. Coupons for Delta Detergent are distributed in newspapers, for example, and are redeemable at any retailer, including retailers 6 and 10. Coupons are financed under budget 23 in manufacturer 4. Budget 23 is essentially a type of monetary amount for another product promotion and discount program for Delta Detergent.

Manufacturer 3 is the Lighthouse Company. The product line of the Lighthouse Company includes Lighthouse Light Bulbs. To stimulate sales, manufacturer 3 finances product promotions consisting essentially of advertised customer discounts on sales of Lighthouse Light Bulbs occurring only within retailer 6. These promotions specific to retailer 6 are financed under budget 24 in manufacturer 3. Budget 24 is essentially a type of monetary amount for a product promotion and discount program for Lighthouse Light Bulbs.

To stimulate sales, manufacturer 3 also issues printed coupons, redeemable for a discount on Lighthouse Light Bulbs. Coupons for Lighthouse Light Bulbs are distributed in newspapers, for example, and are redeemable at any retailer, including retailers 6 and 10. Coupons are financed under budget 25 in manufacturer 3. Budget 25 is essentially another type of monetary amount for a product promotion and discount program for Light House Light Bulbs.

In reliance on signals generated by system 1, manufacturer 4 reimburses retailer 6 for the discount given to customers, as described in more detail below.

Retailer 6 is the ECO grocery store chain. Retailer 6 includes grocery stores 42, 44 and 46. Computer systems 50 in stores 42, 44 and 46 detect discounted purchases and send a purchase report to system 16, via telecommunications signal paths 30, 32, and 34. System 16, located in Athens, Georgia, receives signals from signal paths 30, 32, and 34 to generate a report for manufacturer 4, and sends the report to manufacturer 4 via signal path 38. Manufacturer 4 receives the report from system 16. In response to the report from system 16, manufacturer 4 generates reimbursement for retailer 6.

System 16 also receives signals from signal path 30,32, and 34 to generate a report for manufacturer 3, and sends the report to manufacturer 3 via signal path 35. Manufacturer 3 receives the report from system 16. In response to the report from system 16, manufacturer 3 generates reimbursement for retailer 6.

Processes performed by the circuitry of the exemplary embodiments are described below. In this Patent Application, the word circuitry encompasses dedicated hardware, and/or programmable hardware, such as a CPU or reconfigurable logic array, in combination with programming data, such as sequentially fetched CPU instructions or programming data for a reconfigurable array.

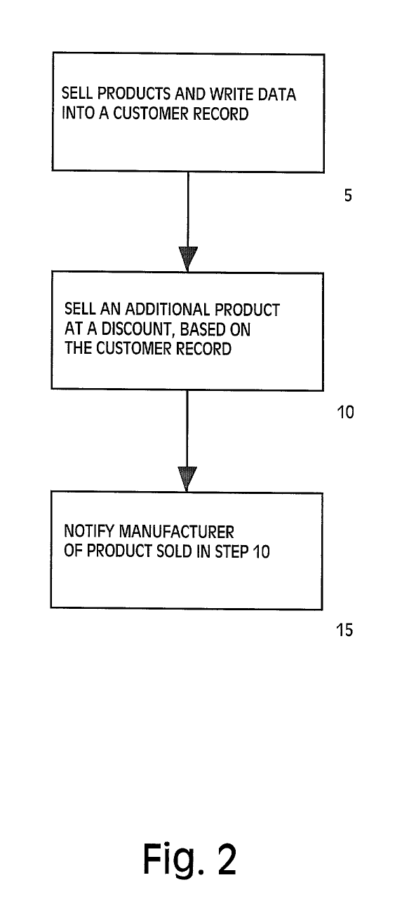

FIG. 2 shows a processing performed in system 1. One or more of stores 42, 44, and 46 sells products and accumulates data reflecting sale amounts into a record for a customer (step 5). One of stores 42, 44, or 46 sells an additional product at a discount, based on the customer record (step 10). The additional product is provided by a manufacturer that funds the discount. In this example, the funding manufacturer is manufacturer 4 or manufacturer 3. The store that performs step 10 is not necessarily the same store, or stores, that performs step 5.

System 16 receives and accumulates data about products sold at the discount of step 10, and notifies the funding manufacturer of such sales. (step 15). The funding manufacturer then reimburses retailer 6 for the discount amount.

System 1 will now be described in more detail. System 1 presents customers with a loyalty-based multilevel discount plan. The level of discount enjoyed by a customer, of retailer 6, depends on an amount of purchases and timing of purchases with retailer 6. More particularly, in this example, the level of discount in a particular month depends on an amount of purchases in the previous month. To qualify as a “Silver Level” shopper, or household, the amount in the previous month must exceed $100. To qualify as a “Gold Level” shopper, the amount in the previous month must exceed $200.

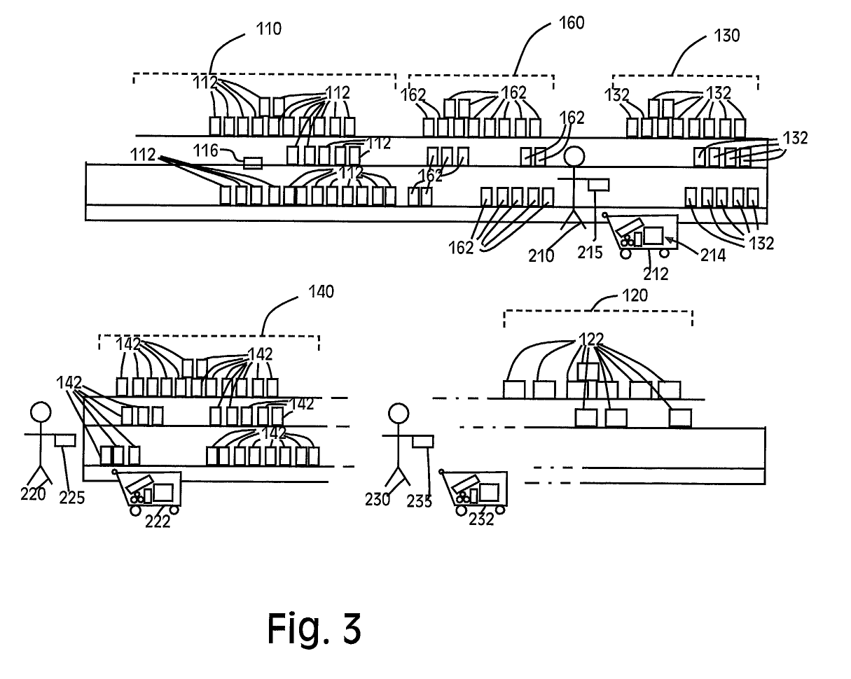

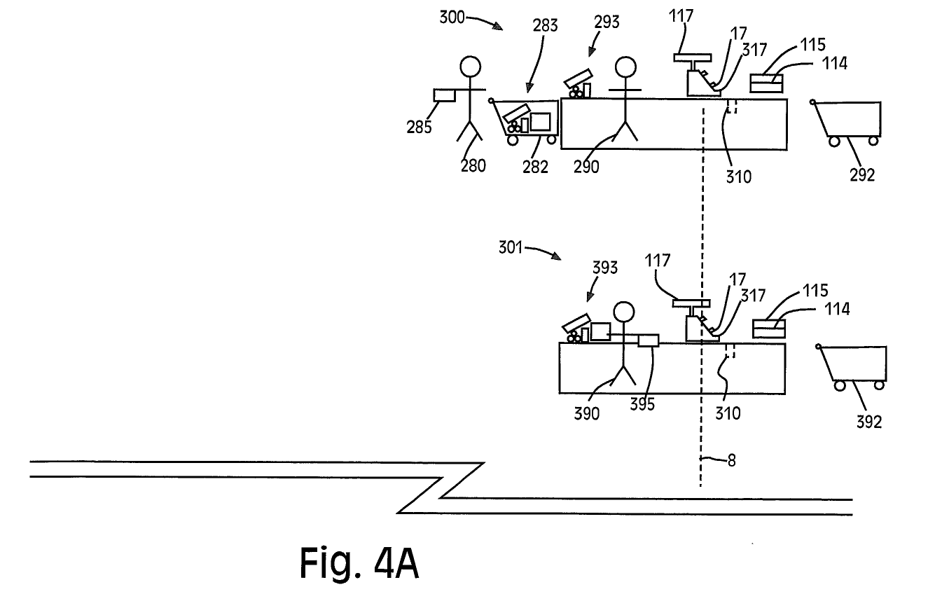

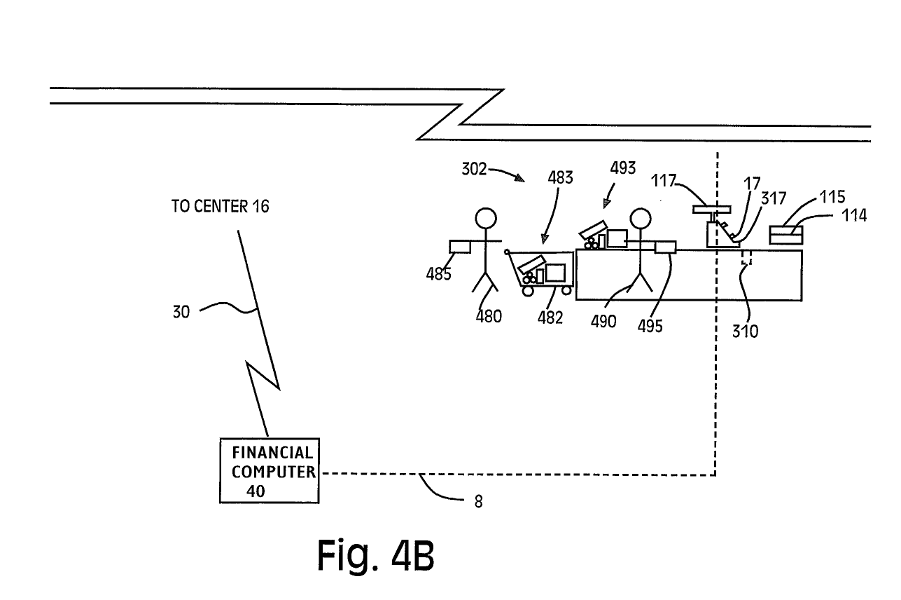

FIGS. 3, 4A, and 4B are each a partial view of store 44 in retailer 6. Store 44 has a plurality of product areas, each corresponding to a respective product. For example, product area 110 has bottles 112 of Delta Detergent. Each bottle of detergent 112 has a common Universal Product Code (UPC) symbol, which is a group of parallel lines encoding a number typically called a “bar code.” This number is part of a product identification system documented by the Uniform Code Council, Inc., Dayton, Ohio. The first digit is a number system character, which in this case is 0. The next five digits are a manufacturer ID. The next 5 digits are an item number. The last digit is a check digit. UPC product code 0 17075 42312 3 uniquely identifies Delta Detergent.

Product area 120 has boxes of pasta 122. Each box of pasta 122 has a common UPC symbol encoding a UPC product code (0 17031 00005 3) uniquely identifying Old World pasta.

Product area 130 has boxes of light bulbs 132. Each box of light bulbs 132 has a common UPC symbol encoding a UPC product code (0 17054 1017 6) uniquely identifying Lighthouse light bulbs. Similarly, other product areas in store 44 each have a set of respective products contiguously grouped together. Respective units of a certain product have a common UPC symbol, different from UPC symbols on units of other products, that uniquely identifies the certain product. Respective units of a certain product also have a common human readable word label, different from labels on units of other products, that uniquely identifies the certain product with words. Product area 140 has bottles of ABC brand ketchup 142 contiguously grouped together. Product area 160 has loaves of Boxer brand bread 162 contiguously grouped together.

From time to time, system 1 promotes certain products with a multilevel pricing display. For example, FIG. 3 shows shelf label 116 adjacent to Delta Detergent.

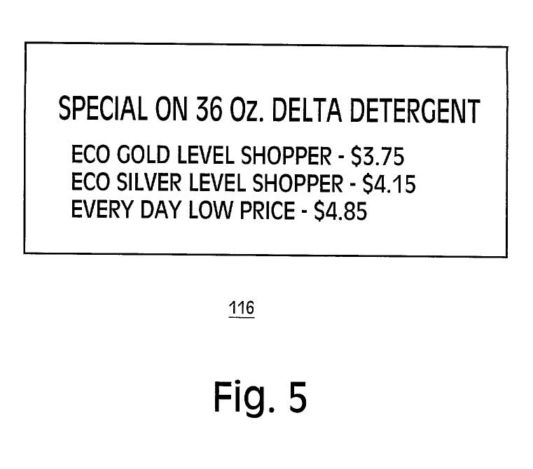

FIG. 5 shows shelf label 116 in more detail.

Computer system 50 includes ethernet cable 8 and 4 computers: financial computer 40, and a computer in each of checkout station 300, checkout station 301, and checkout station 302. Each of these computers has a respective network address uniquely identifying it in on cable 8, and circuitry for recognizing when a packet containing its address is sent over cable 8, temporarily storing such a packet, and processing the packet contents when such a packet is recognized.

Customers 210, 220, 230, 280, and 290, shop in store 44. Some of the customers, such as customer 210 in FIG. 3, carry an electronic card, such as customer card 215, which is approximately the length and width of a typical financial credit card. While shopping in store 1, each of customers 210, 220, 230, 280, and 290 carries his or her respective customer card. Customer 210 carries card 215, customer 220 carries card 225, customer 230 carries card 235, and customer 280 carries card 285. Each customer removes one or more desired products from a shelf and places the removed product into her cart. Customer 210 pushes cart 212 and selects products 214. Customer 220 pushes cart 222, and customer 230 pushes cart 232.

Upon completion of shopping, the customer brings selected products from the shelves to checkout station 300, 301, or 302. A customer may present her customer card for insertion into interface slot 114 of smart card reader/writer 115. For example, referring to FIGS. 2, 3, and 4B, customer 280 completes the purchase of her selected products 283 by transferring products 283 from her cart 282 to station 300, and by presenting card 285. Similarly, customer 290 completes the purchase of her selected products 293 by transferring products 293 from her cart 292 to station 300 and customer 390 completes the purchase of her selected products 393 by transferring products 393 from her cart 392 to station 301, and presenting card 395. Customer 480 completes the purchase of her selected products 483 by transferring products 483 from her cart 482 to station 302, and presenting card 485, while customer 490 completes the purchase of her selected products 493 by transferring products 493 to station 302, and presenting card 495. A checkout clerk (not shown) then scans each product 283 past bar code reader 310, or enters the product selection information manually via keyboard 317, allowing station 300 to generate a UPC product code for the most recently processed product.

Checkout Processing in the First Preferred Embodiment—Generation of Points

Station 300 may also write retailer points onto the customer's card. Station 300 scans and processes each product 293 in a similar manner.

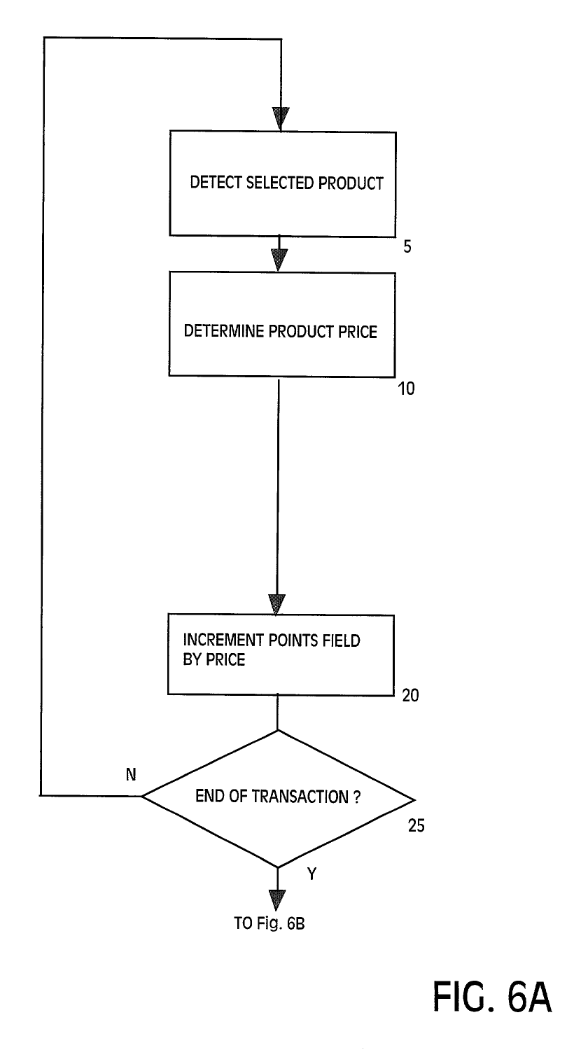

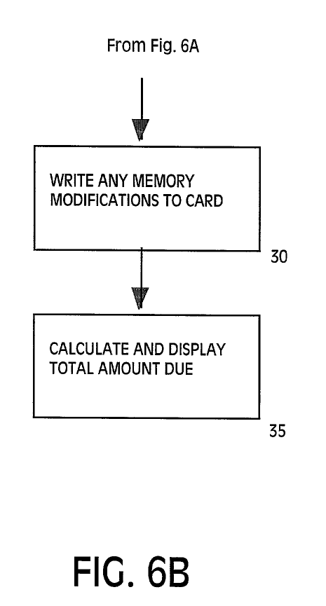

FIGS. 6A and 6B show the processing of step 5 of FIG. 5 in more detail. Station 300 detects a product selected by a customer, by receiving a UPC product code from bar code reader 310 or keyboard 318. (step 5). Station 300 determines a price for the product, by processing a message from financial computer 40. (step 10). Station 300 increments the current month's points field in a card by the price of the product. (step 20). If the checkout transaction for the current customer is complete (step 25), station 300 writes any card memory modifications to the customer card. (step 30). Station 300 determines a total amount due depending on the sum of the product prices from the various executions of step 10, minus any product discounts. Station 300 displays this total amount due on display 117 and the customer's receipt tape. (Step 35).

Checkout Processing in the First Preferred Embodiment—Multilevel Pricing

A customer may bring selected products from the shelves to checkout station 300, 301, or 302, as described above. A customer may present her customer card, allowing the store clerk to insert the presented card into smart card reader/writer 115. Station 300, 301, or 302 then reads the points data from the card. Station 300, for example, performs discount processing, by processing the selected products in the context of current product promotions and customer points data to determine discount eligibility. After station 300 determines a basic price for each product by processing a message received from computer 40, station 300 deducts any discounts from the basic price to calculate and display a total amount due.

More Detailed Description of the First Preferred Embodiment

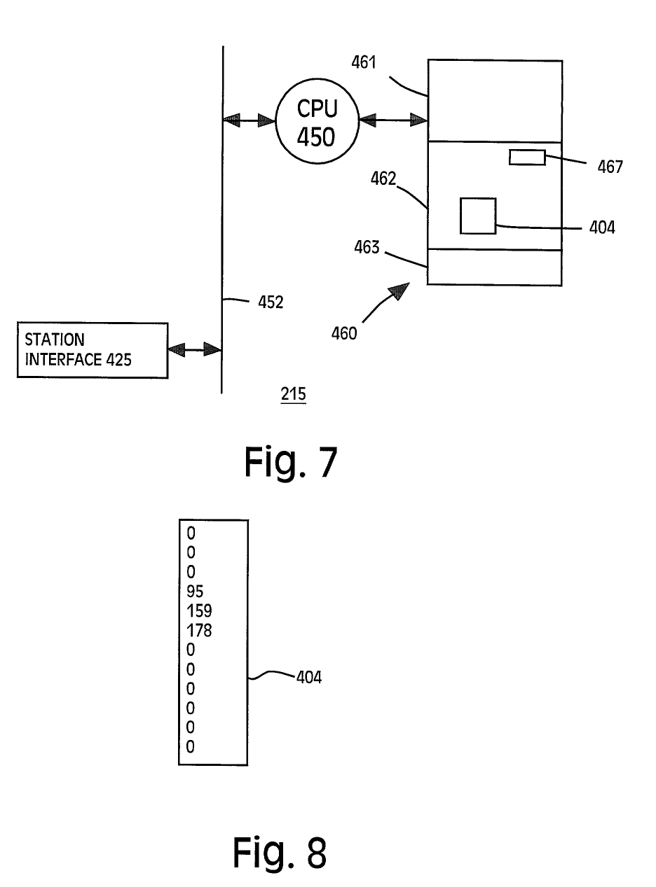

FIG. 7 is a block diagram of customer card 215, including CPU 450, and memory 460. Memory 460 includes three addressable segments: nonvolatile read only memory (ROM) 461; nonvolatile, electrically erasable memory (EEPROM) 462; and memory 463 for temporary storage. Station interface 425 includes a serial to parallel converter for transferring data signals between contacts, on the exterior of card 215, and CPU 450 over parallel bus 452. ROM 461 stores a program 465 executed by CPU 450. EEPROM 462 stores customer card identification data 467. Customer card identification data 467 is a 6 byte field that uniquely identifies the card. For example, identification data 467 in customer card 235 uniquely identifies the card held by customer 230. EEPROM 462 also stores retailer points table 404. When purchasing a product at a checkout station, the checkout station may increment the value of a points field in retailer's points table 404.

Each of customer cards 235, 245, 275, 285, 395, 475, 485, and 495 have the same hardware structure as card 215.

FIG. 8 shows a simplified, abstract, view of retailer points table 404. Retailer points table 404 is a data structure within other data structures in EEPROM 462. Each row in table 404 represents an entry in table 404. The first entry, currently 0, indicates an amount of purchases in the first month of the year, January. The second entry, currently 0, indicates an amount of purchases in second month of the year, February, etc. At the time of the example shown in FIG. 8, the month is June. Thus, the amount of the purchases in the previous month, May, is in the fifth entry, currently 159.

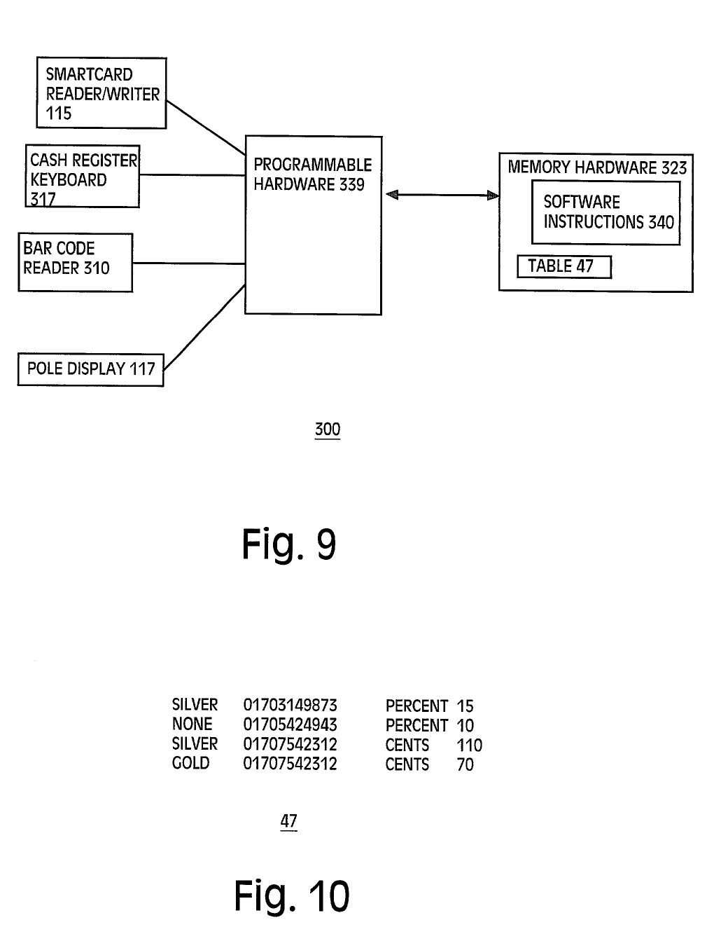

FIG. 9 is a block diagram of checkout station 300. Programmable hardware 339 executes software instructions 340 in memory hardware 323. Cash register keyboard 317 allows manual entry of alpha-numeric data. Bar code reader 310 generates a bar code signal, and sends the bar code signal to hardware 339. Poll display 117 displays product data in response to signals from hardware 339. Hardware 339 and software instructions 340 act to receive data from a customer card, via reader/writer 115. Memory hardware 323 stores control table 47, enabling hardware 339 to determine if a product has a corresponding discount offer.

When station 300 detects insertion of a customer card into reader/writer 115, station 300 reads retailer points table 404 into a temporary version of table 404 in memory hardware 323. After detecting a product selected by the customer (See FIG. 6A step 5), hardware 339 increments the points field by the product price. (See FIG. 6A step 20). At the conclusion of the checkout transaction, hardware 339 writes the temporary version of table 404, stored in memory hardware 323, to the customer card. (See FIG. 6B step 30).

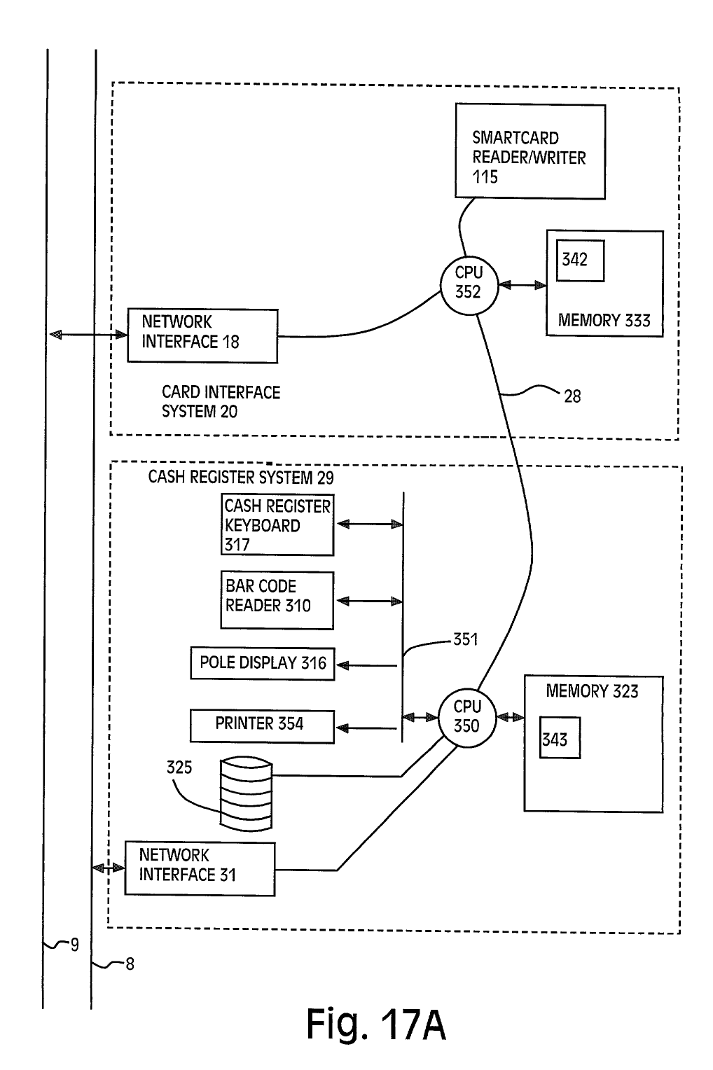

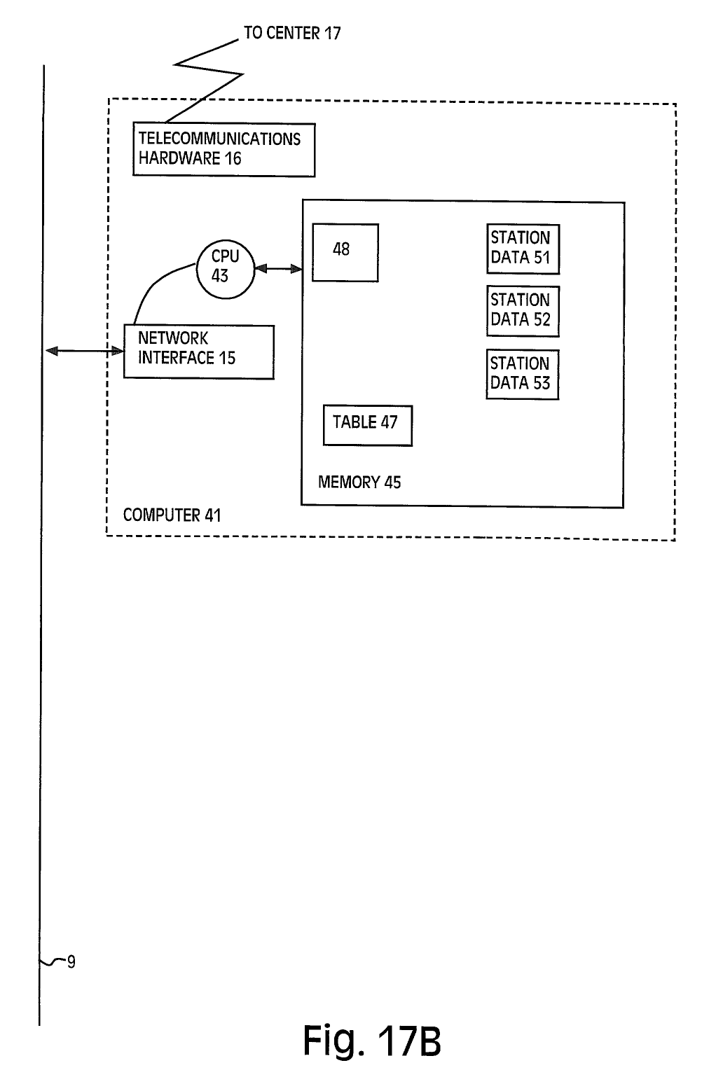

FIG. 10 is a simplified diagram of control table 47 stored in card interface station 300. Each row in FIG. 17 represents an entry in table 47, and each of the 4 columns shown represents an entry field. A redemption control table may include additional entries for additional discount offers, and additional fields for recording other types of information.

The first field in table 47 is a discount level, a symbol representing a point threshold. “Silver” represents $100, and “Gold” represents $200, as described above. The first field may also contain “None” representing $0, meaning that any customer may qualify for the discount regardless of accumulated points.

The second field is a UPC product code corresponding to the discount ID.

The third field is a reward type, indicating either a percent off discount, and or a cents off discount.

The fourth field in table 47 is the reward quantity.

The first entry shows a reward of 15 percent off. The first entry is for a product having a product number of 49873, from a company having a company ID of 017031.

The second entry shows a reward quantity of 10 percent off. The second entry is for a product having a product number of 24943, from a company having a company ID of 017054.

The third entry shows a “Silver” level threshold, and a reward quantity of 70 cents off for the product having the product number 42312 from the company having the ID 017075, which is the Delta Company.

The fourth entry shows a “Gold” level threshold, and a reward quantity of 110 cents off for the product having the product number 42312 from the company having the company ID 017075, which is the Delta Company.

Thus, table 47 stores two discount entries for the same product, Delta Detergent, each discount entry having a different reward value.

Checkout stations 301 and 302 each have the same capabilities and hardware as checkout station 300.

Processing of step 35 of FIGS. 6A and 6B will now be described in more detail. When hardware 339 receives a valid UPC product code from reader 310 or keyboard 318, hardware 339 adds the product code to a basket list for the current customer. Hardware 339 searches for the received product code in the second field of control table 47, enabling hardware 339 to determine if the product has a corresponding entry in table 47. If the product does have an electronic discount offer, hardware 339 compares the discount level of the found table 47 entry to the previous month's entry in table 404, from the customer card, to confirm that the customer is qualified to receive the discount represented by the entry. If the customer is qualified, hardware 339 adjusts the total amount due by the discount amount of the offer.

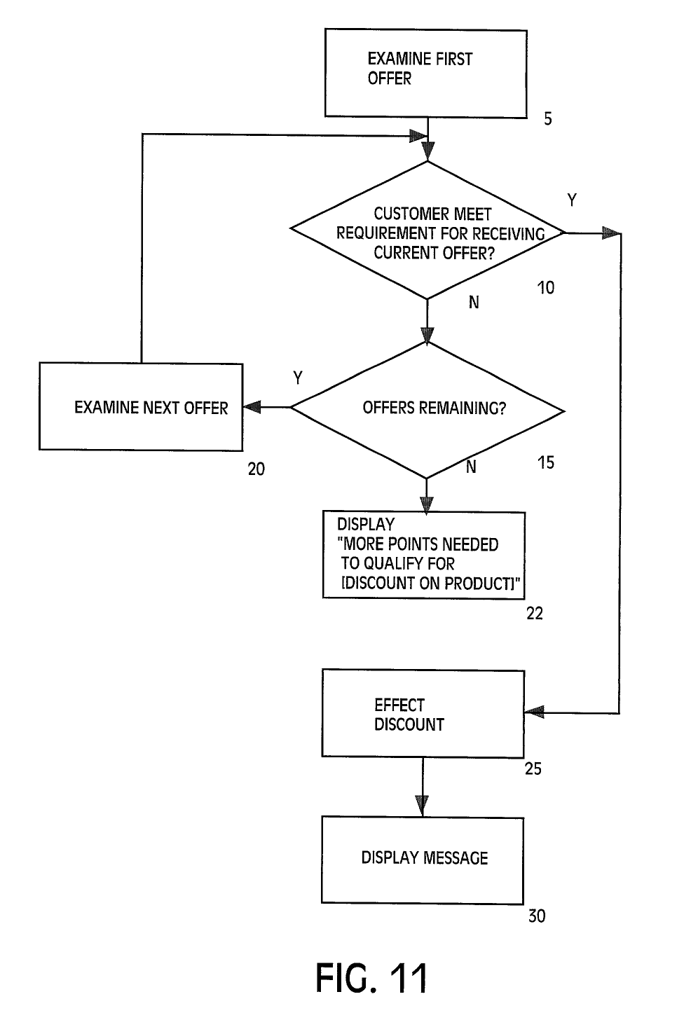

FIG. 11 shows a processing performed by hardware 339 when a product does have an offer in table 47. Hardware 339 examines the first table 47 entry for the product. (step 5). Hardware 339 determines whether the customer is qualified to receive the discount of the entry. Any customer will be qualified if the discount threshold is 0, symbolized by “None” in table 47. Hardware 339 examines data from the customer card to determine whether the customer's retailer points, for the previous month, exceed the threshold of the entry. (Step 10). If the customer's retailer points do not exceed the threshold of the current entry, hardware 339 determines whether there are entries remaining for the product. (step 15). If there are entries remaining, hardware 339 examines the remaining entries to determine whether the customer meets the requirements for receiving one of the remaining discount offers. (Steps 20, 10, etc.). If the customer does meet the requirements for receiving one of the offers hardware 339, hardware 339 adjusts the total amount due by discount amount.( Step 25), and displays a message to the customer indicating the discount received. (Step 30).

If the customer is not eligible to receive any of the discounts in table 47, hardware 339 displays a message to indicate how additional points are required, by displaying the difference between the relevant points on the card and the lowest threshold for the product in table 47. (Step 22).

Programmable hardware may include an IBM 46804690 Point of Sale (POS) System. Programable hardware 339 may include two CPUs, as disclosed in copending application Ser. No. 09/301,749 of KEN R. POWELL, KEVIN W. HARTLEY, ELEANOR B. MAXWELL, and COREY C. SNOOK for COMPUTER SYSTEM CONFIGURATION AND METHOD FOR A STORE, filed Apr. 29, 1999, the contents of which is herein incorporated by reference. Alternately, hardware 339 may be a single CPU having electronic discount, or other discount, processing integrated with conventional UPC product scanning and price lookup. Memory hardware 323 may include two independent memories or may be an integrated memory.

To perfect a discounted transaction, the system 16 orders a transfer of the discount amount, from the manufacturer to the retailer. Following the example above, when a Silver Level customer buys Delta Brand Detergent, the system 16 bills $00.70, the normal price minus the discount price, to Delta Corporation.

Thus, the first preferred system includes manufacturers 3 and 4 in mutual competition, and a single retailer 6. Retailer 6 includes system 16. System 16 sends respective bills to manufacturers 3 and 4, in response to discount transactions within retailer 6.

Second Preferred Embodiment

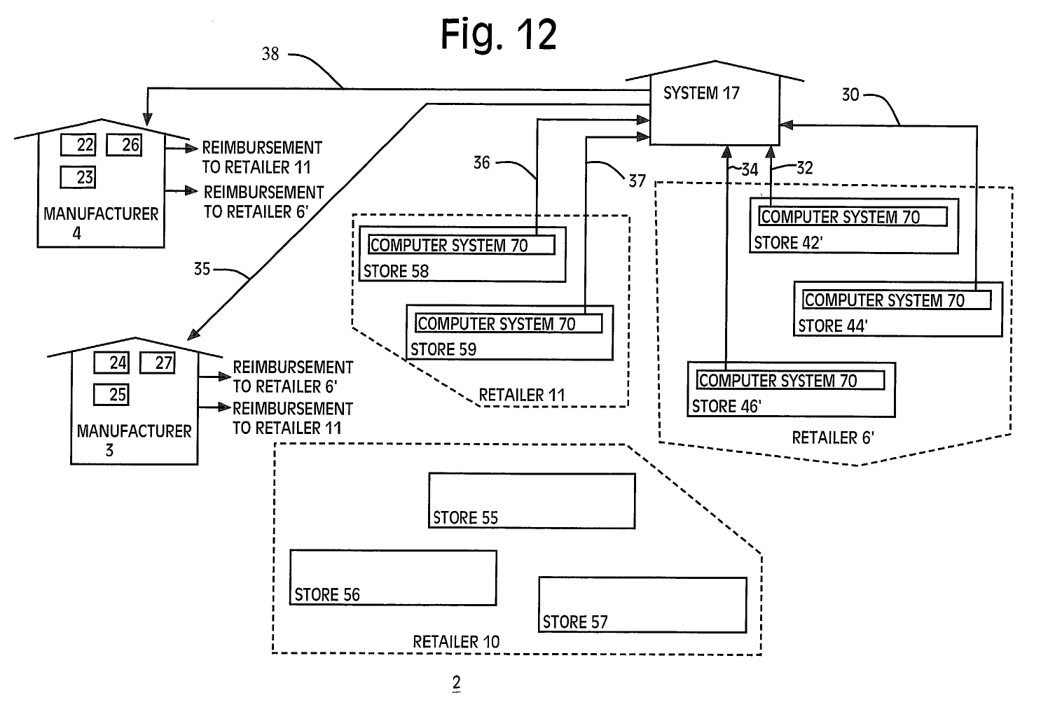

FIG. 12 shows system 2, a system of commercial promotion in accordance with a preferred embodiment of the present invention. System 17 communicates with retailer 6, retailer 11, manufacturer 4, and manufacturer 3. Retailers 6, 10, and 11 are in mutual competition. System 17 is a business separate from each of manufacturer 4, and manufacturer 3, retailers 6, retailer 10, and retailer 11.

To stimulate sales, manufacturer 4 finances product promotions consisting essentially of advertised customer discounts on sales of Delta Detergent occurring only within retailer 6. These promotions specific to retailer 6 are financed under budget 22 in manufacturer 4. Budget 22 is a type of monetary amount for a product promotion and discount program for Delta Detergent.

To stimulate sales, manufacturer 4 finances product promotion consisting essentially of customer discounts on sales of Delta Detergent occurring within retailer 11. These promotions specific to retailer 11 are financed under budget 26 in manufacturer 4. Budget 26 is essentially a type of monetary amount for another product promotion and discount program for Delta Detergent.

To stimulate sales, manufacturer 4 also issues printed coupons, redeemable for a discount on Delta Detergent. Coupons for Delta Detergent are distributed in newspapers, for example, and are redeemable at any retailer, including retailers 6, 10, and 11. Coupons are financed under budget 23 in manufacturer 4. Budget 23 is essentially a type of monetary amount for another product promotion and discount program for Delta Detergent.

To stimulate sales, manufacturer 3 finances product promotions consisting essentially of advertised customer discounts on sales of Lighthouse Light Bulbs occurring only within retailer 6. These promotions specific to retailer 6 are financed under budget 24 in manufacturer 3. Budget 24 is essentially a type of monetary amount for a product promotion and discount program for Lighthouse Light Bulbs.

To stimulate sales, manufacturer 3 finances product promotion consisting essentially of customer discounts on sales of Lighthouse Light Bulbs occurring within retailer 11. These promotions specific to retailer 11 are financed under budget 27 in manufacturer 3. Budget 27 is essentially a type of monetary amount for another product promotion and discount program for Lighthouse Light Bulbs.

To stimulate sales, manufacturer 3 also issues printed coupons, redeemable for a discount on Lighthouse Light Bulbs. Coupons for Lighthouse Light Bulbs are distributed in newspapers, for example, and are redeemable at any retailer, including retailers 6, 10, and 11. Coupons are financed under budget 25 in manufacturer 3. Budget 25 is essentially a type of monetary amount for another product promotion and discount program for Lighthouse Light Bulbs.

Retailer 6′ is the ECO grocery store chain. Retailer 6′ includes grocery stores 42, 44 and 46. Computer systems 70 in stores 42′, 44′ and 46′ detect discounted purchases and send a purchase report to system 17, via telecommunications signal paths 30, 32, and 34.

Retailer 11 includes a grocery store chain owned by Healthy Inc. Retailer 11 operates grocery stores 58 and 59. Computer systems 70 in stores 58 and 59 detect discounted purchases and send a purchase report to system 17, via telecommunications signal paths 36 and 37.

System 17, located in Athens, Ga., receives signals from signal paths 30, 32, 34, 36, and 37 to generate a report for manufacturer 4, and sends the report to manufacturer 4 via signal path 38. Manufacturer 4 receives the report from system 17. In response to the report from system 17, manufacturer 4 generates reimbursement for retailer 6′. In response to the report from system 17, manufacturer 4 generates reimbursement data for retailer 11.

System 17 also receives a signals from signal path 30, 32, 34, 36, and 37 to generate a report for manufacturer 3, and sends the report to manufacturer 3 via signal path 35. Manufacturer 3 receives the report from system 17. In response to the report from system 17, manufacturer 3 generates reimbursement for retailer 6′. In the response to the report from system 17, manufacturer 3 generates reimbursement data for retailer 11.

In summary, system 2 essentially enables a type of price discount with a contract between a manufacturer and a retailer, and with circuitry in the manufacturer and the retailer. For example, system 2 sets up a type of retail price adjustment, by allocating a budget 26 and creating a contract between manufacturer 4 and retailer 11. The contract provides for a retail price of $3.95 or $4.25, instead of $4.85, for Delta Detergent and for manufacturer 4 to reimburse, or otherwise credit, retailer 11 for each consumer purchase made at the discount price.

For example, system 2 allocates a budget 22 and creates a contract between manufacturer 4 and retailer 6. The contract provides for a retail price of $3.95 or $4.25, instead of $4.85, for Delta Detergent and for manufacturer 4 to reimburse, or otherwise credit, retailer 6 for each consumer purchase made at the discount price.

For example, system 2 allocates a budget 27 and creates a contract between manufacturer 3 and retailer 11. The contract provides for a retail price of $2.15 or $2.65, instead of $2.95, for Lighthouse Light Bulbs and for manufacturer 3 to reimburse, or otherwise credit, retailer 11 for each consumer purchase made at the discount price.

For example, system 2 allocates a budget 24 and creates a contract between manufacturer 3 and retailer 6. The contract provides for a retail price of $2.15 or $2.65, instead of $2.95, for Lighthouse Light Bulbs and for manufacturer 3 to reimburse, or otherwise credit, retailer 6 for each consumer purchase made at the discount price.

System 2 will now be described in more detail. System 2 presents customers with loyalty-based multilevel discount plans. The level of discount enjoyed by a customer of retailer 6′ depends on an amount of purchases and timing of purchases with retailer 6′. The level of discount enjoyed by a customer of retailer 11 depends on an amount of purchases and timing of purchases with retailer 11.

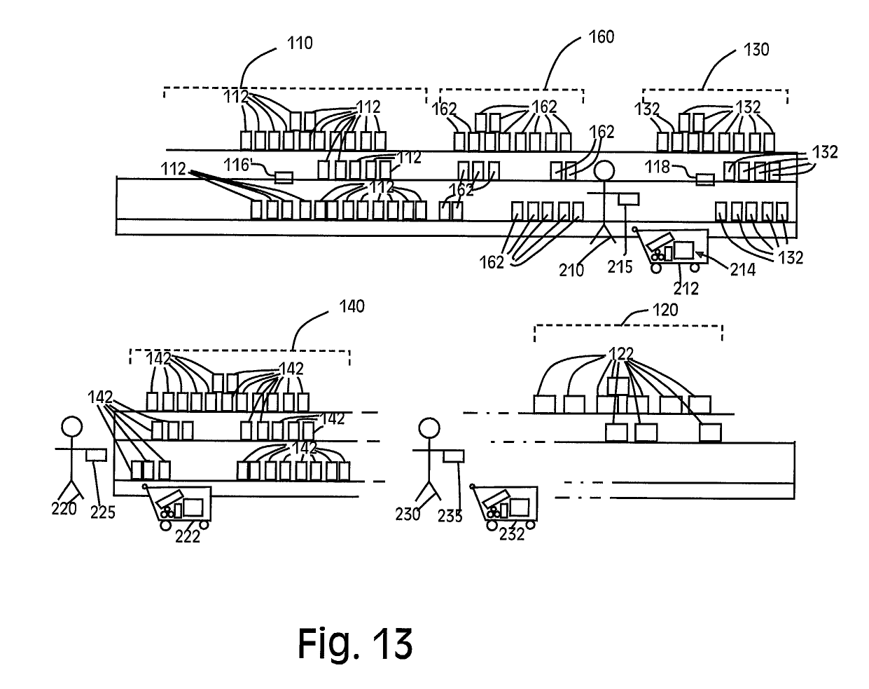

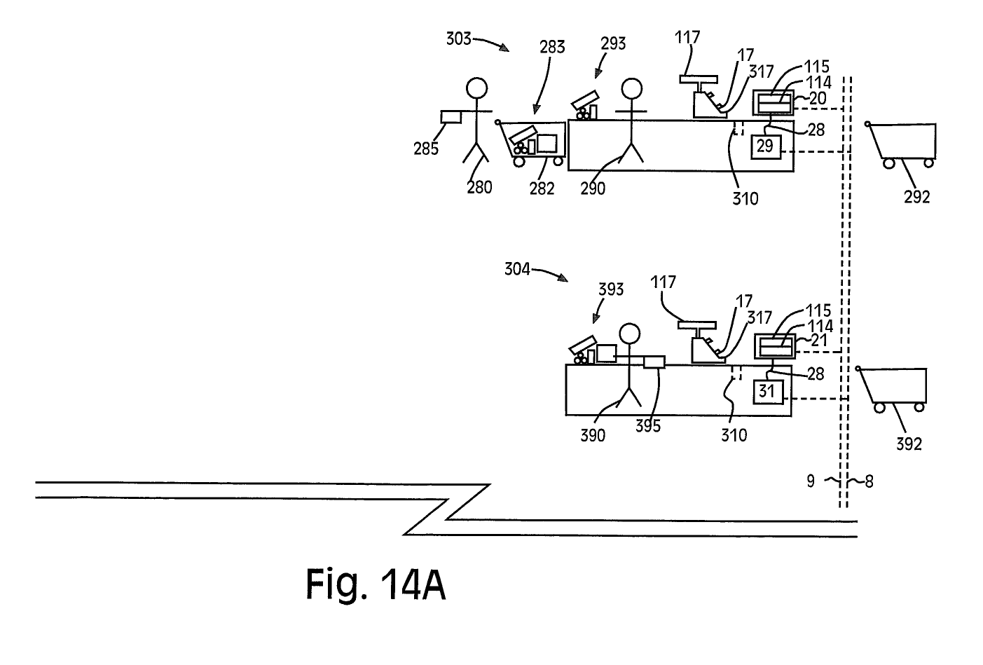

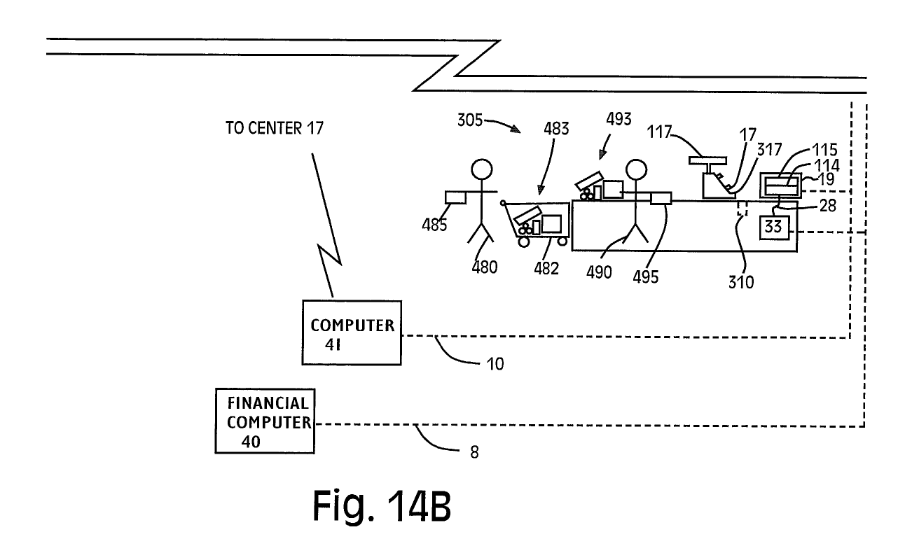

FIGS. 13, 14A, and 14B are each a partial view of store 58 in retailer 11. Store 58 has a plurality of product areas, each corresponding to a respective product, as described above in connection with store 44.

From time to time, system 2 promotes certain products with a multilevel pricing display. For example, FIG. 13 shows shelf label 116′ adjacent to Delta Detergent and shelf label 118 adjacent to Lighthouse Light Bulbs.

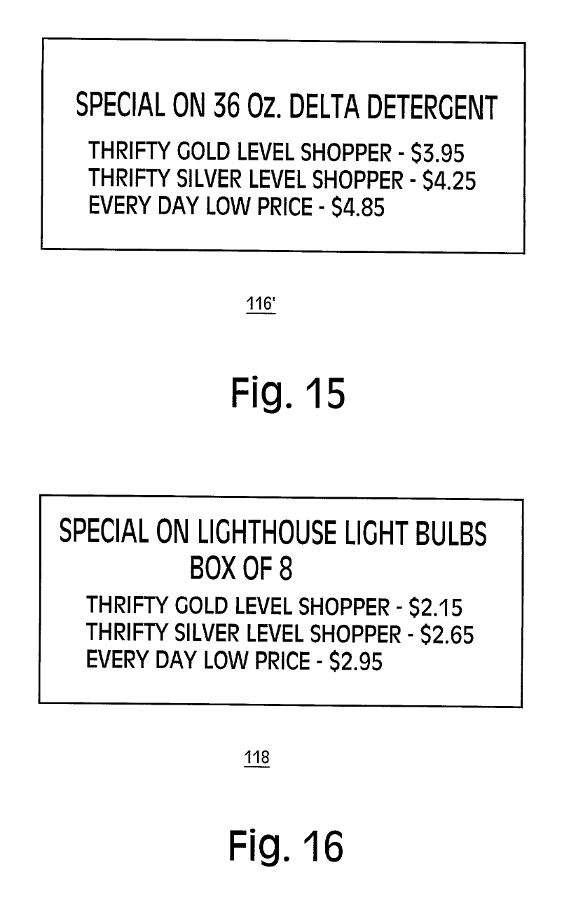

FIG. 15 shows shelf label 116′ in more detail.

FIG. 16 shows shelf label 118 in more detail.

FIGS. 17A and 17B are a block diagram of computer 41 and checkout station 303. Checkout station 303 includes cash register system 29, serial data cable 28, and card interface system 20. Similarly, checkout station 304 includes cash register system 31, serial data cable 28, and card interface system 21, while checkout station 3 05 includes cash register system 33, serial data cable 28, and card interface system 19. Cash register system 29 includes an IBM 4680-4690 Point of Sale System. CPU 350 executes instructions 343 in random access, addressable memory 323. CPU 350 communicates with cash register keyboard 317, bar code reader 310, pole display 316, and printer 354 via RS-485 serial bus 351. Cash register keyboard 317 allows manual entry of alpha-numeric-data. Bar code reader 310 generates a bar code signal, and sends the bar code signal to CPU 350. Poll display 316 displays product data in response to signals from CPU 350. Disk 325 provides long term storage. Network interface 31 enables communication between ethernet cable 8 and CPU 350.

In card interface system 20, CPU 352 executes program 342 in random access, addressable memory 333. CPU 352 and program 342 act to receive retailer points data from a customer card, via reader/writer 115. Network interface 18 enables communication between cable 9 and CPU 352.

A physical layer includes an RS-232 asynchronous serial connection on which CPU 350 in system 29 communicates with CPU 352 in system 20 via RS232 line 28.

A data link layer between systems 29 and 20 includes a frame with a start code octet, one or more data octets, a checksum octet, and an end code octet. Every frame transmitted requires an ACK/NAK response. When system 20 receives a frame with a correct checksum, system 20 sends an ACK response; otherwise system 20 sends a NAK response. If system 29 does not receive a response within a reasonable amount of time, system 29 declares a timeout condition and resend the frame.

An application layer between systems 29 and 20 includes a series of commands and responses, as discussed in more detail below.

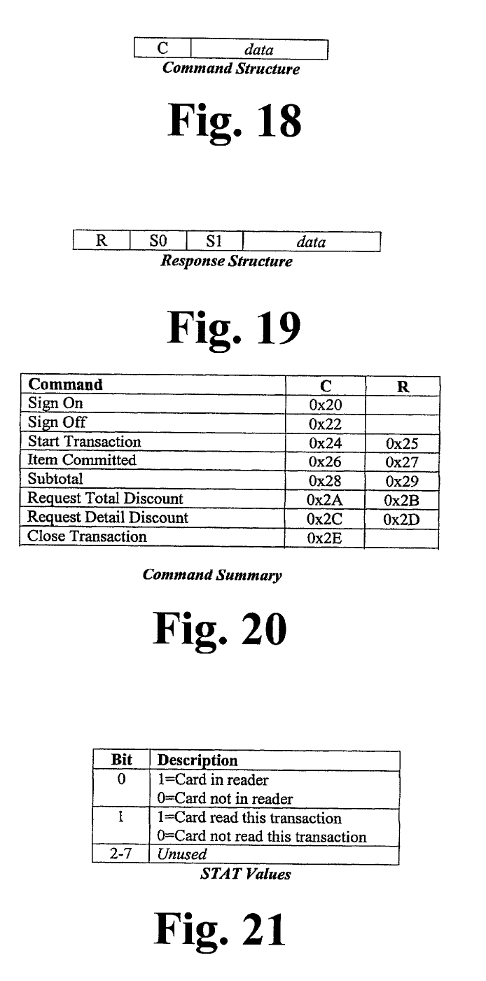

FIG. 18 shows the structure of a command packet including a single command octet followed by 0 or more data octets. Some commands require a response while others do not, as summarized in FIG. 20.

FIG. 19 shows the structure of a response packet including status octets S0 and S1 followed by zero or more data octets. SO shows the current status of the customer card, and S1 is an error bit mask for the received parameters. The bits in SO are shown in FIG. 21. Each bit in S1 corresponds to a parameter in the command. A 1 in a bit position of S1 indicates an error condition with the corresponding parameter position. For example, if system 20 receives a command with an invalid value for the second parameter P1, system 20 sends a response with bit 1 of S1 set to one 1.

FIG. 12 summarizes some commands sent from system 29 to system 20 in the application layer supported by the data link layer, which in turn is supported by the physical layer. The Sign On command notifies system 20 of a register sign-on event. Any transaction process in progress is terminated. All counters are cleared and system 20 awaits the next command from register system 29. There are no parameters associated with this command, and there is no response generated.

The Sign Off command notifies system 20 of a register sign-off event. Any transaction process in progress is terminated. All counters are cleared and system 20 awaits the next command from register system 29. There are no parameters associated with this command, and there is no response generated.

The Start Transaction command notifies system 20 of the start of a new transaction. Any transaction in process in progress is terminated. Computer 41 commands the checkout station to read retailer points data 404 from the customer's card. Card interface system 20, in response to the read command, reads retailer points data 404 from the customer's card and sends points data 404 to computer 41 via cable 9. All counters are cleared and system 20 awaits the next command from register system 29.

The Item Committed command notifies system 20 of item committed event. Five parameters for the Item Committed command are described in Table 1 below.

TABLE 1

| | |
|---|---|
| P0 | Sales type |

0 × 30 = Normal Sales
0 × 31 = Refund/Return
0 × 34 = Cancel Normal Sales
0 × 35 = Cancel Refund/Return

| | |
|---|---|
| P1 | UPC product code. (12 digits, packed decimal). |
| P2 | Price. (4 digits, packed decimal). |
| P3 | Quantity. (3 digits, packed decimal). |
| P4 | Weight. (6 digits, packed decimal). |

The Subtotal command notifies system 20 of the current subtotal amount in parameter P0. Receiving this command causes system 20 to calculate the discount data based on the Item Committed commands received during this transaction. Therefore, this command must precede the Request Total Discount and Request Detail Discount commands. There is no response associated with this command.

The Request Total Discount command requests system 20 to return the total discount for this transaction. This command has 2 response parameters, R0 and R1. R0 is the number of products representing total discount. R1 is the total discount amount, which is the value of the variable TOTAL_DISCOUNT_AMOUNT described below.

The Request Detail Discount command requests system 20 to return the first or next discount depending on the value of P0, with P0=0 representing the first discount and P0=any other value representing the next discount. A response where R0-R1 are all zeroes indicates the end of the discount list. Otherwise, response parameters R0-R1 include, respectively, UPC product code and discount amount.

The Close Transaction command notifies system 20 of the end of the current transaction. Any transaction process in progress is terminated. Computer 41 commands the checkout station to write updated points data 404 back to the customer card. Thus, the customer card will reflect any points generated for the current month, by the transaction being closed. All counters are cleared and system 20 awaits the next command from register system 29. There is no response associated with this command.

It is presently preferred that sending of commands from system 29 be implemented by customizing system 29 with a “user exits,” which are a standardized mechanism by which the IBM 4860-4690 system calls custom routines, as described in the IBM 4680-4690 Supermarket Application: Programming Guide, SC30-3634, Third Edition (January 1997). Some exits employed in this customization may include TSUPEC2—After a Customer Checkout Transaction is Completed, and TSUPEC14—After Reading the Keyboard/Scanner, and TSUPEC23—Before Writing a Line to the Display.

When system 20 receives an application layer command from system 29, system 20 sends the command to computer 41. In response to receiving a command, computer 41 sends any needed response to system 20, and system 20 then sends the response to system 29.

During a checkout transaction for a customer at station 303, computer 41 maintains station data 51. Station data 51 includes data about transactions at checkout station 303, including retailer points data 404 from the customer's card, and a list of products selected by the customer.

During the checkout transaction for a customer at station 304, computer 41 maintains station data 52. Station data 52 includes data about transactions at checkout station 304, including retailer points data 404 from the customer's card, a list of products selected by the customer.

During the checkout transaction for a customer at station 305, computer 41 maintains station data 53. Station data 53 includes data about transactions at checkout station 305, including retailer points data 404 from the customer's card, a list of products selected by the customer.

In computer 41, CPU 43 executes instructions 48 in random access, addressable memory 45. Memory 45 stores control table 47, enabling CPU 43 to determine if a customer-selected product has a corresponding electronic promotion. Network interface 15 allows communication between cable 9 and CPU 43.

When computer 41 receives a Subtotal command, computer 41 selects each product in the basket list and searches for the selected product code in UPC product code fields of control table 47, thus enabling computer 41 to determine if the product has a corresponding electronic promotion.

When computer 41 receives an Item Committed command identifying a product selected by a customer at station 303, computer 41 adds the product to a basket list in station data 51. Computer 41 searches for the received UPC product code in the second field of control table 47, enabling computer 41 to determine if the product has a corresponding entry in table 47. If the product does have an electronic discount offer, computer 41 compares the discount level of the found table 47 entry to the previous month's entry in table 404, from the customer card, to confirm that the customer is qualified to receive the discount represented by the entry. If the customer is qualified, computer 41 adjusts the variable TOTAL_DISCOUNT_AMOUNT by the amount of the discount offer.

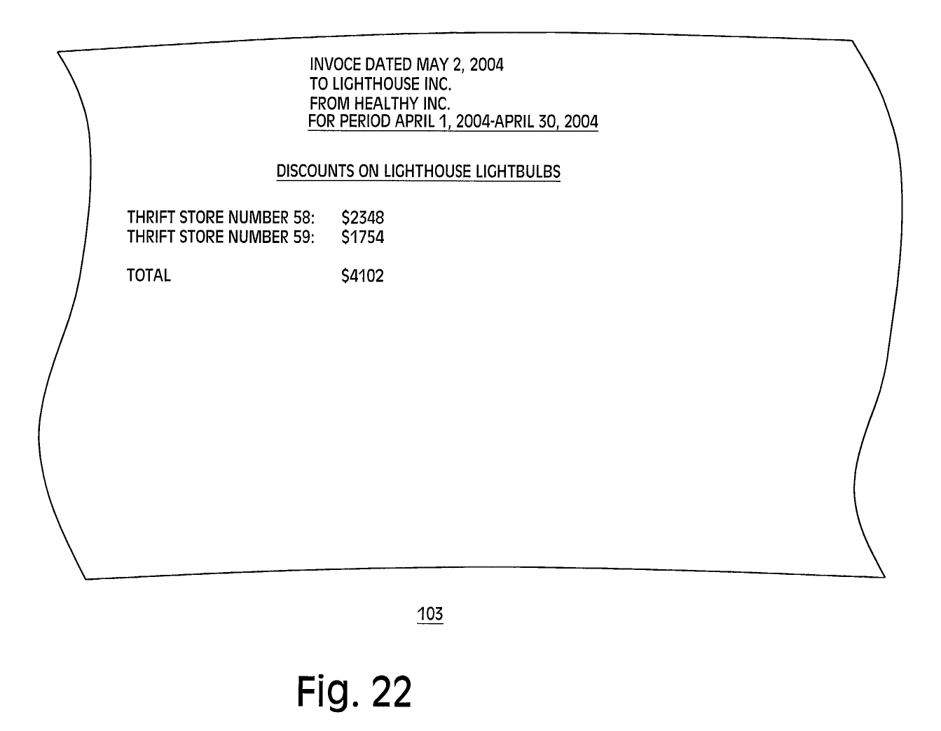

Computer 41 sends a report to system 17. In response to the report, system 17 generates an invoice document 103 as shown in FIG. 22. System 17 sends invoice document 103, which is a bill for manufacturer 3, to manufacturer 3 via signal path 35. Bill 103 is essentially a type of signal corresponding to a transfer of funds from manufacturer 3 to retailer 11. System 2 generates this signal in response to discounted purchases. Manufacturer 3 includes circuitry that essentially subtracts the amounts in bill 103 from budget 27.

Checkout stations 304 and 305 each have the same circuitry as that of as checkout station 303.

In summary, system 2 essentially effects a purchase with a consumer and retailer 11, for example, and generates retailer 11 points. Subsequently, system 2 selectively enables a price adjustment for a subsequent purchase with retailer 11, depending on a quantity of retailer 11 points generated by previous purchases by the consumer. Responsive to this price-adjusted purchase, system 2 generates a bill requesting that the manufacturer, of the product subjected to the price-adjusted purchase, reimburse retailer 11 for the price adjustment.

The point-generating purchase and the subsequent price-adjusted purchase are not necessarily performed in the same store. For example, a customer may perform the point-generating purchase transaction in store 59 and subsequently perform a price-adjusted purchase transaction in store 58, responsive to the points generated in store 59.

In the second preferred system, the price-adjusted purchase transaction does not decrease the quantity of accumulated points. In an alternate embodiment, the price-adjusted purchase does decrease the quantity of accumulated points.

The illustrated customer card may be dedicated to storing point for a particular retailer. Alternately, the illustrated card may be multi-application cards with a storage area for retailer 11 points, and a separate storage area for retailer 6′ points.

Although the second preferred system employs customer cards for storing the respective retailer points of the customers, points may be stored at various alternate locations, including, for example, a central database. In other words, systems may have a customer card for storing retailer points, a customer card for identification purposes only, or no customer card.

Qualification criteria may be presented to the consumer in various formats, as a points threshold, a dollars threshold, or other types of levels, for example.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims. In general, the words “first,” “second,” etc., employed in the claims do not necessarily denote an order.

What is claimed is:

1. A method for a system including a manufacturer and a retailer, the method comprising:
enabling a discounted purchase responsive to previous purchases with the retailer; and
generating a signal corresponding to a transfer of funds from the manufacturer to the retailer, responsive to the discounted purchase.

2. A method for a system including a retailer, and a plurality of manufacturers each associated with a respective product, the method comprising:
effecting a first purchase with the retailer;
selectively enabling a price adjustment for a second purchase with the retailer, the enabling being responsive to the first purchase;
effecting the second purchase; and
generating a signal corresponding to a transfer of funds from a selected manufacturer to the retailer, responsive to a second purchase, wherein the manufacturer is selected depending on a product subjected to the second purchase.

3. The method of claim 2 wherein effecting the first purchase increases a quantity stored on a customer's card.

4. The method of claim 2 wherein effecting the first purchase increases a quantity and effecting the second purchase does not reduce the quantity.

5. The method of claim 2 wherein the method further includes effecting a plurality of first purchases to generate a first signal and enabling includes comparing the first signal to a threshold.

6. The method of claim 2 wherein effecting the first purchase increases a quantity and effecting the second purchase reduces the quantity.

7. The method of claim 2 wherein the system includes a store having shelves, products on the shelves, and a display supported by the shelf, the display displaying a discount level for a product, and the method further includes effecting the second purchase in accordance with the display.

8. The method of claim 2 wherein
effecting a first purchase includes effecting the first purchase in a first store of the retailer, and
effecting a second purchase includes effecting a second purchase in a second store of the retailer.

9. The method of claim 3 wherein the plurality of manufacturers are in mutual competition.

10. The method of claim 2 wherein the plurality of manufacturers include a first manufacturer having a computer system storing a first monetary amount, corresponding to the price adjustment, and a second monetary amount corresponding to a different system of discounts for the product.

11. A processing system for a first system including a manufacturer and a retailer, the processing system comprising:
a plurality of first processors, in store checkout systems, that enable a discounted purchase responsive to previous purchases with the retailer; and
a second processor that generates a signal corresponding to a transfer of funds from the manufacturer to the retailer, responsive to the discounted purchase.

12. A processing system for a first system including a retailer, and a plurality of manufacturers each associated with a respective product, the processing system comprising:
a first checkout station for effecting a first purchase with the retailer;
a first processor that selectively enables a price adjustment for a second purchase with the retailer, the enabling being responsive to the first purchase;
a second checkout station for effecting the second purchase; and
a second processor that generates a signal corresponding to a transfer of funds from a selected manufacturer to the retailer, responsive to a second purchase, wherein the manufacturer is selected depending on a product subjected to the second purchase.

13. The processing system of claim 12 wherein the first processor is removed from the second checkout station.

14. The processing system of claim 12 wherein the first checkout station includes circuitry that increases a quantity and the second checkout station includes circuitry that does not reduce the quantity.

15. The processing system of claim 12 wherein the first checkout station includes circuitry that increases a quantity stored on a customer's card.

16. The processing system of claim 12 wherein the first processor includes a comparator that compares a quantity, associated with a customer, to a threshold.

17. The processing system of claim 12 wherein the retailer includes a store having shelves, products on the shelves, and a display supported by the shelf, the display displaying a discount level for a product, and the second checkout station acts to effect the second purchase in accordance with the display.

18. The processing system of claim 12 wherein
the first checkout station is in a first store of the retailer, and
the second checkout station is in a second store of the retailer.

19. A processing system for a first system including a manufacturer and a retailer, the processing system comprising:
means for enabling a discounted purchase responsive to previous purchases with the retailer; and
means for generating a signal corresponding to a transfer of funds from the manufacturer to the retailer, responsive to the discounted purchase.

20. A processing system for a first system including a retailer, and a plurality of manufacturers each associated with a respective product, the processing system comprising:
means for effecting a first purchase with the retailer;
means for selectively enabling a price adjustment for a second purchase with the retailer, the enabling being responsive to the first purchase;
means for effecting the second purchase; and
means for generating a signal corresponding to a transfer of funds from a selected manufacturer to the retailer, responsive to a second purchase, wherein the manufacturer is selected depending on a product subjected to the second purchase.

21. The processing system of claim 20 wherein means for effecting the first purchase increases a quantity and means for effecting the second purchase does not reduce the quantity.

22. The processing system of claim 20 wherein the means for selectively enabling is removed from the second checkout station.

23. The processing system of claim 20 wherein the means for effecting a first purchase includes circuitry that increases a quantity and the means for effecting the second purchase includes circuitry that does not reduce the quantity.

24. The processing system of claim 20 wherein the means for effecting the first purchase includes circuitry that increases a quantity stored on a customer's card.

25. The processing system of claim 20 wherein the means for selectively enabling includes a comparator that compares a quantity, associated with a customer, to a threshold.

26. The processing system of claim 20 wherein the retailer includes a store having shelves, products on the shelves, and a display supported by the shelf, the display displaying a discount level for a product, and the means for effecting the second purchase acts to effect the second purchase in accordance with the display.

27. The processing system of claim 20 wherein
the means for effecting the first purchase is in a first store of the retailer, and
the means for effecting the second purchase is in a second store of the retailer.
